(19) United States
(12) Patent Application Publication
(10) Pub. No.: US 2026/0081488 A1
(43) Pub. Date: Mar. 19, 2026

(54) RETAINER FOR AN INTERNAL PERMANENT MAGNET ROTOR, AND METHOD

(71) Applicant: BorgWarner Inc., Auburn Hills, MI (US)

(72) Inventors: Attila Nagy, Fishers, IN (US); Andrew Dragon, Fishers, IN (US); Kirk Neet, Noblesville, IN (US)

(21) Appl. No.: 18/888,400

(22) Filed: Sep. 18, 2024

(51) Int. Cl. H02K 1/276

(52) U.S. Cl. CPC H02K 1/276

(57) ABSTRACT

A retainer for an internal permanent magnet rotor, including a body having a first end and a second end, a first anchor feature at the first end, and a tensioner feature disposed along the body and configured to draw the first end toward the second end. An internal permanent magnet rotor, including a rotor lamination having a magnet opening, a magnet housed in the magnet opening, a pole piece, and a retainer, connecting the lamination and the pole piece. A method for assembling an internal permanent magnet (IPM) rotor, including installing a magnet in a magnet opening of the IPM rotor, and disposing a retainer into the IPM rotor.

### BACKGROUND OF THE INVENTION

Those of skill in the art will recognize that bridges are generally needed between a lamination body and a pole piece to ensure permanent magnet retention during rotary operation of the rotor of an electric machine. Bridges, while effective for the purpose of retention, unfortunately cause flux loss. Flux loss is undesirable. Accordingly, some attempts have been made to reduce flux loss through the use of devices colloquially termed “dog bones” that are constructed from non magnetically permeable material. Such devices have not performed particularly well with regard to retention and tend to allow permanent magnet movement. Amplitude of movement increases with the square of rotational velocity of the rotor. Since retention while still avoiding flux loss remains a target for the art, additional innovation is needed.

### BRIEF DESCRIPTION OF THE INVENTION

Disclosed is an embodiment of a retainer for an internal permanent magnet rotor, including a body having a first end and a second end, a first anchor feature at the first end, and a tensioner feature disposed along the body and configured to draw the first end toward the second end.

Disclosed is an embodiment of an internal permanent magnet rotor, including a rotor lamination having a magnet opening, a magnet housed in the magnet opening, a pole piece, and a retainer, connecting the lamination and the pole piece.

Disclosed is an embodiment of a method for assembling an internal permanent magnet (IPM) rotor, including installing a magnet in a magnet opening of the IPM rotor, and disposing a retainer into the IPM rotor.

### BRIEF DESCRIPTION OF THE DRAWINGS

The following descriptions should not be considered limiting in any way. With reference to the accompanying drawings, like elements are numbered alike:

FIG. 1 is a perspective view of a rotor 10 as disclosed herein;

FIG. 2 is a perspective view of a retainer as disclosed herein;

FIG. 3 is an enlarged view of a portion of the rotor 10 of FIG. 1;

FIG. 4 is a view to illustrate a first geometry of the first anchor feature;

FIG. 5 is a view to illustrate a second geometry of the first anchor feature;

FIG. 6 is a view to illustrate a third geometry of the first anchor feature;

FIG. 7 is an enlarged view of an alternate embodiment of the rotor 10 disclosed herein;

FIGS. 8-12 are each enlarged views of additional embodiments of the rotor 10 disclosed herein.

### DETAILED DESCRIPTION OF THE INVENTION

A detailed description of one or more embodiments of the disclosed apparatus and method are presented herein by way of exemplification and not limitation with reference to the Figures.

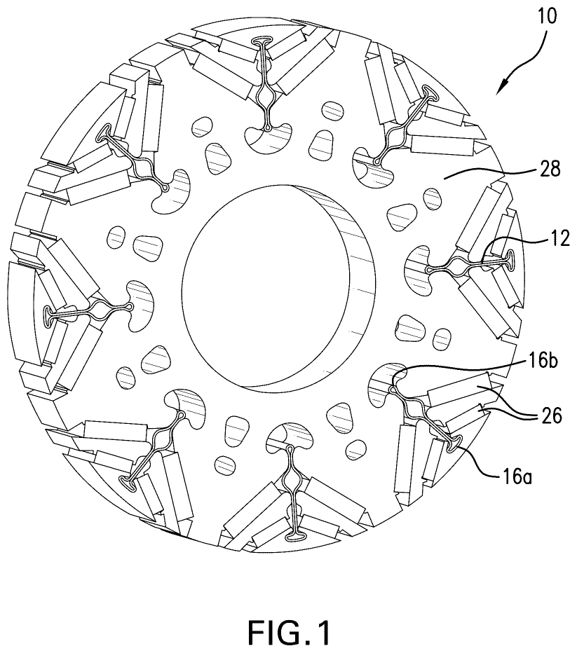

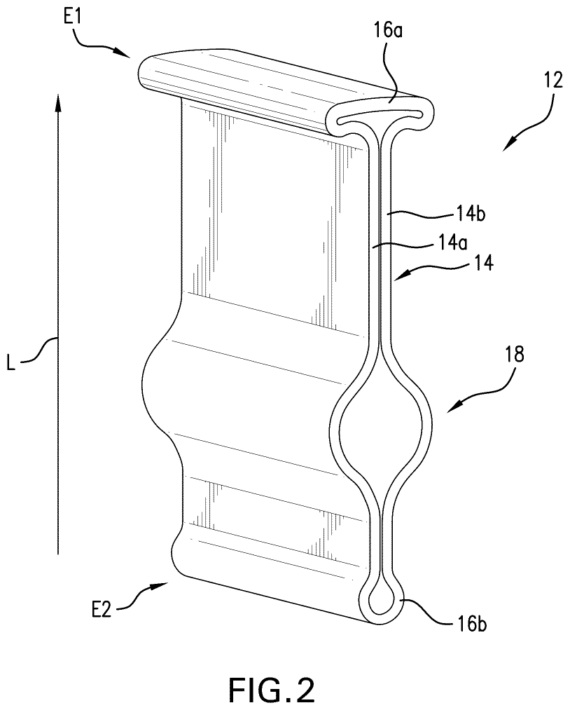

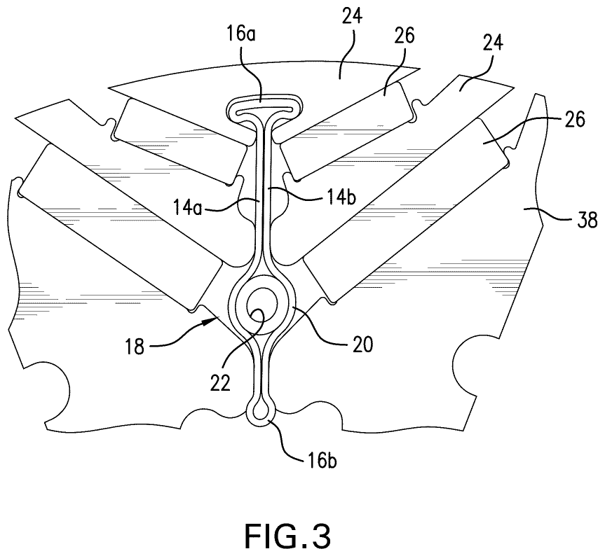

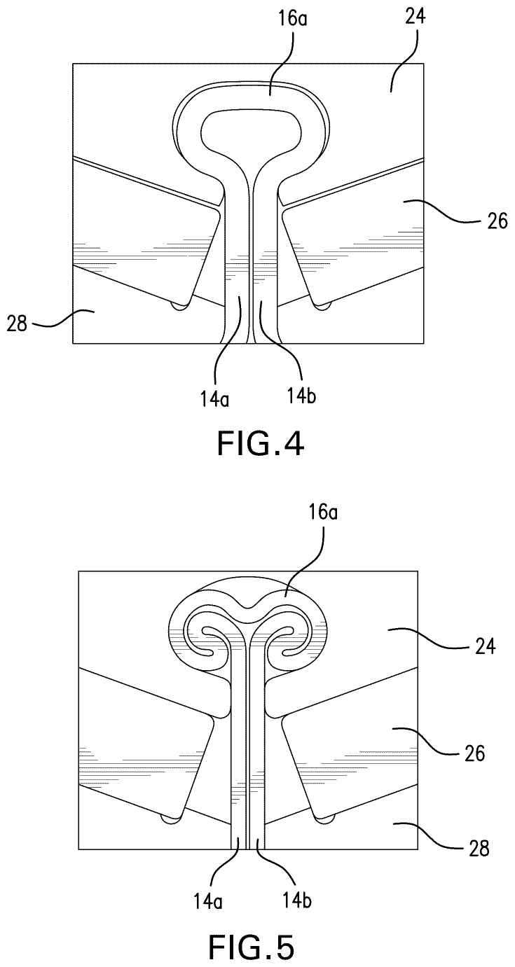

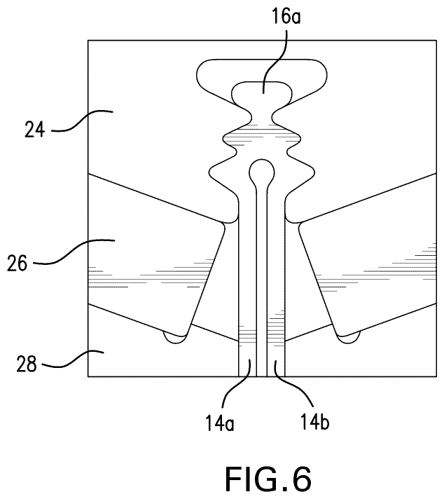

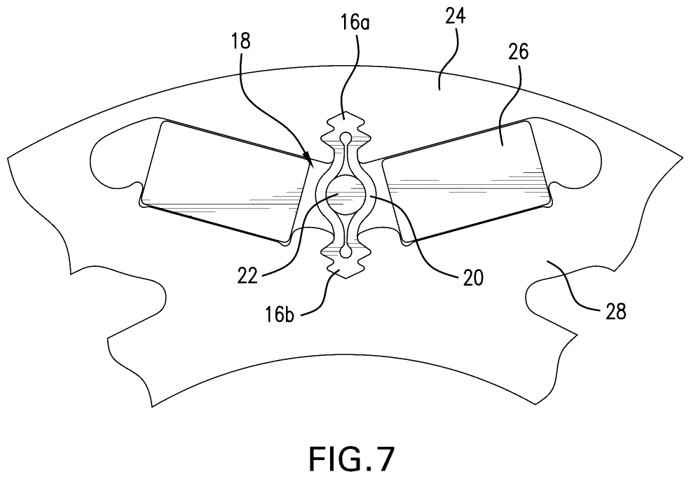

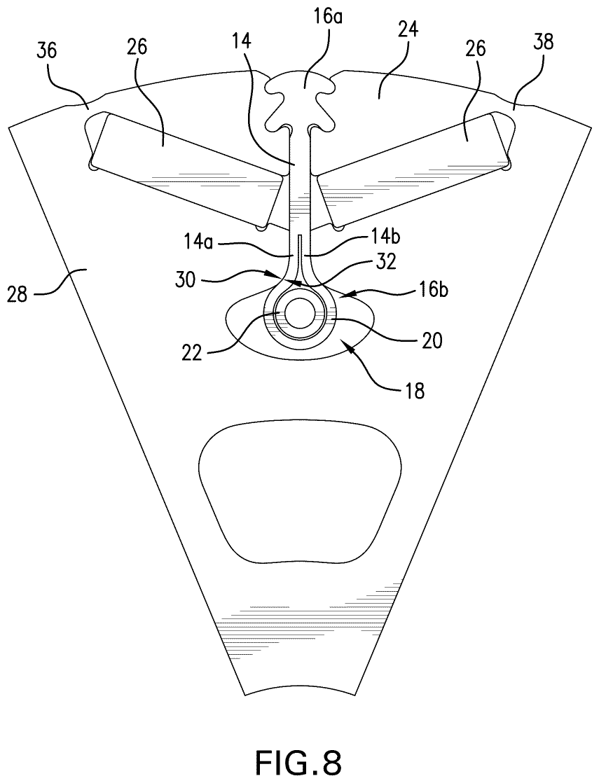

Referring to FIG. 1, an illustration of an IPM rotor 10 employing a retainer 12 as disclosed herein is illustrated. Retainer 12 provides both a reduction in flux loss and a reliable retention of magnets therein. The retainer 12 may be constructed of a magnetically permeable material but in some embodiments the retainer 12 is constructed of a non magnetically permeable material. The rotor has magnet openings which each house a magnet. The IPM rotor shown in FIG. 1 is double V type rotor as each pole has at least four magnets 26 arranged in a double V pattern. In another embodiment, shown in FIG. 7, the IPM rotor is a single V type rotor as each pole only has two magnets 26 formed into a V shape. Referring to FIG. 2, the retainer 12 comprises a body 14 having an anchor feature 16 and a tensioner feature 18. Various thicknesses for the body 14 are in a range of about 0.6 to about 1.2 millimeters (mm). Body 14 may comprise one or more adjacent segments (identified by lower case alpha characters in the figures, e.g. 14a, 14b) and a first end E1 and a second end E2. The anchor feature 16 may take a number of forms including the geometries illustrated in any of FIGS. 1-12. It is to be appreciated that the anchor feature 16 geometry, as illustrated, may be on one end or both ends of the retainer 12, whereby a first anchor feature 16a and a second anchor feature 16b are, in some embodiments disposed on either end of the body 14, as is illustrated for example in FIG. 7. It is also to be appreciated that either the first anchor feature 16a or the second anchor feature 16b could be additionally configured as the tensioner feature 18 or the tensioner feature 18 may be distinct from the first or second anchor features. Tensioner features 18 are distinct from the anchor features in the embodiments illustrated in FIGS. 1-3, 7, and 9, while tensioner features 18 that are additionally configured as an anchor feature are illustrated in FIG. 8, and 10-12, for example. In an embodiment, the tension feature 18 is located in between two adjacent magnets 26 as shown in FIGS. 1,3 and 7. In an embodiment, the tensioner feature 18 is a combination of a geometric feature 20 of the body 14 and a separate tensioner 22, such as a wedge or pin that is configured for insertion into the geometric feature 20 of the body 14. In an embodiment that includes the tensioner 22, the tensioner 22 expands the geometric feature 20, thereby longitudinally of the body (see arrow L on FIG. 2) shortening the retainer 12. The tensile load created in the retainer 12 through the action of the tensioner 18 is sufficient to at least offset a radially outward force (centrifugal) on a pole piece 24 of the rotor 10 that is retained by the retainer 12 at all times including during high-speed (e.g. about 5000-about 20,000 rpm) rotation of the rotor 10. Resultingly, the pole piece 24 is inhibited in its ability to move radially outwardly. This means that a designed in compressive load on magnets 26 from the pole piece 24 cannot be reduced by rotation speed of the rotor 10 even at a rotation per minute of 20,000 or more. As will be appreciated by one of skill in the art, reduction in the compressive load on the magnets in the rotor 10 causes deleterious effect on the rotor. Maintaining the compressive load thereon even at speeds of about 20,000 rpm is paramount to rotor function at these speeds. Such maintenance of compressive load has not heretofore been achieved with or without bridges (or thinner bridges than would otherwise be required) in the laminations of the rotor. Additionally, as noted above, bridges cause flux loss.

In an embodiment that does not employ the tensioner 22, the tensioner feature 18 is elastically deformed temporarily to lengthen a longitudinal dimension of the retainer 12. In an embodiment, the retainer looks the same whether the tension feature 18 uses a tensioner 22 or does not since the geometric feature 20 may simply be elastically deformed, thereby producing the longitudinal lengthening of the retainer 12. Releasing the elastic deformation input will allow the retainer 12 to return to its resting shape which is designed (i.e. having a length) to pull the pole piece 24 toward the rest of the rotor 10.

Referring specifically to FIG. 8, an enlarged view of an embodiment of the rotor 10 is illustrated. The rotor 10 includes a lamination 28 and the pole piece 24. The lamination 28 and the pole piece 24 are retained and in fact drawn toward each other by the retainer 12 as discussed above. In the particular embodiment, the tension feature 18 doubles as an anchor feature 16b. The geometric feature 20 is illustrated with a tensioner 22 therein (the particular tensioner being configured as a tubular pin, though as indicated above other configurations are contemplated). It is to be appreciated that a contact zone 30 of the geometric feature 20, which opposes a load surface 32 of the lamination 28 will have a first load prior to insertion of the tensioner 22 and a second higher load after insertion of the tensioner 22. This will effectively draw the pole piece 24 radially inwardly to compress magnets 26 and hold them reliably in place even with rotation speeds of the rotor 10 of 20,000 rpm or even higher. In this embodiment, a 0.4 millimeter (mm) interference fit is employed but a range of interference fit is contemplated from about 0.1 mm to about 0.6 mm. This embodiment does include side bridges 36 and 38 and hence is adapted to higher rotor speeds.

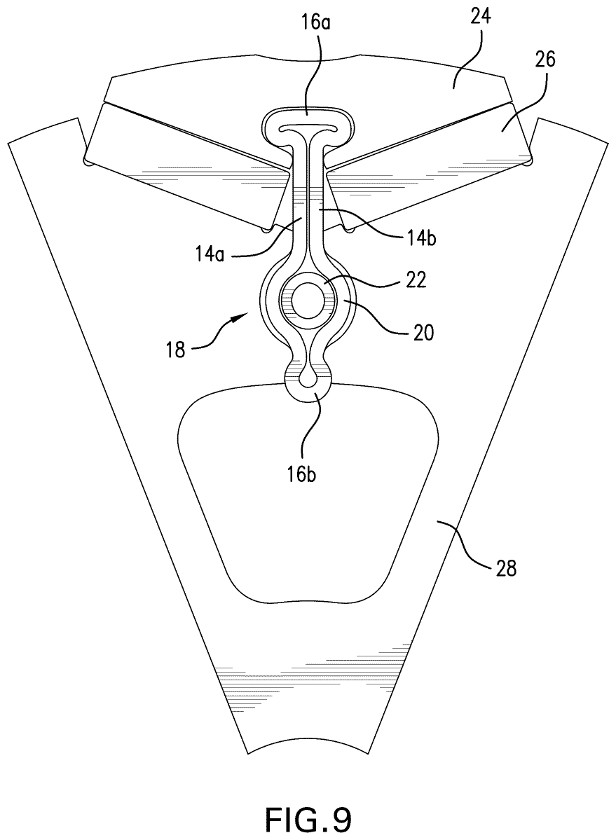

Referring to FIG. 9, another embodiment of the retainer concept disclosed herein is illustrated. In this embodiment, both a first anchor feature 16a and a second anchor feature 16b as well as the tensioner feature 18. The tensioner feature 18 in this embodiment is similar in function to that of FIG. 8 but does not directly also anchor, but rather only shortens the longitudinal length of the retainer 12 to draw the pole piece 24 to the lamination 28 thereby compressing the magnets 26 as above. It should be noted that the side bridges 36 and 38 from FIG. 8 are missing in this embodiment and therefore even less flux loss is experienced in the embodiment.

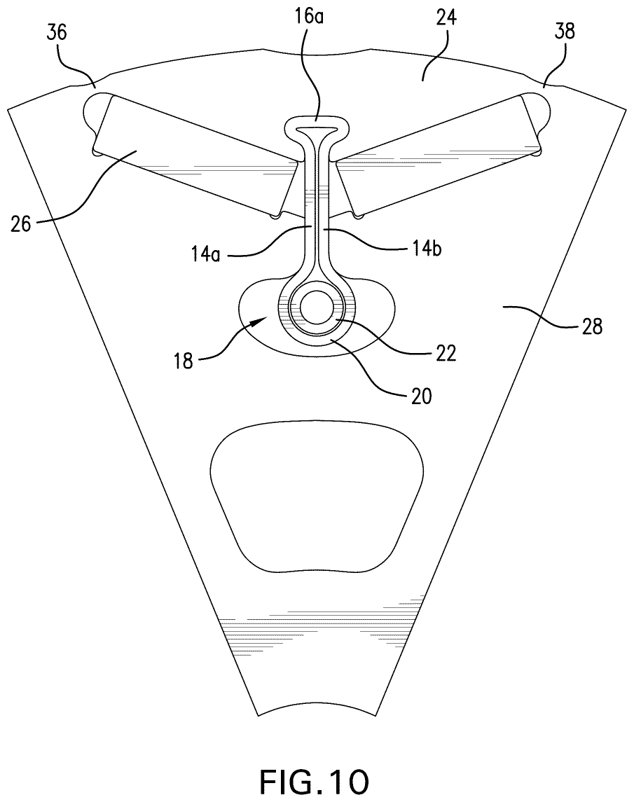

FIG. 10 is very similar to FIG. 8 but for the first anchor feature 16a, which has a different geometry. The function of this embodiment is also similar to that of FIG. 8.

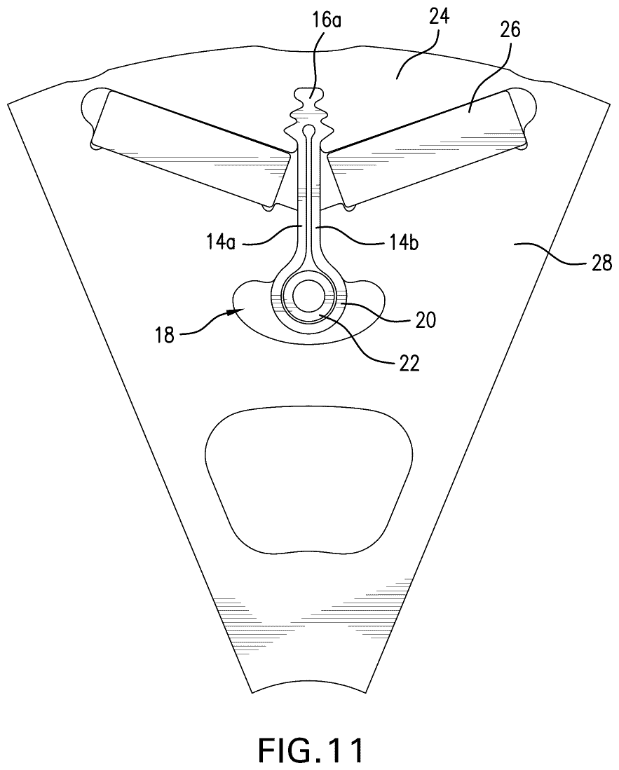

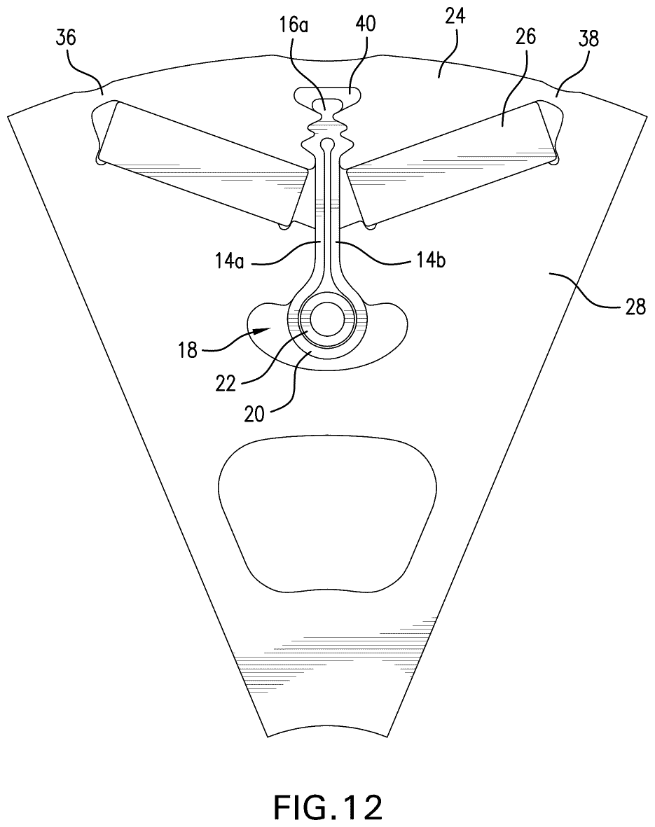

FIGS. 11 and 12 are also similar to FIG. 8 but with a different first anchor feature geometry 16a. FIG. 11 differs from FIG. 12 in that the pole piece 24 is configured with an opening 40 centered at an end of the first anchor feature 16a.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally”can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A retainer for an internal permanent magnet rotor, comprising:
a body having a first end and a second end;
a first anchor feature at the first end; and
a tensioner feature disposed along the body and configured to draw the first end toward the second end.

2. The retainer as claimed in claim 1, wherein the tensioner feature is a geometric feature of the body.

3. The retainer as claimed in claim 2, wherein the geometric feature is elastically deformable to elongate the retainer.

4. The retainer as claimed in claim 1, wherein the tensioner feature includes a wedge.

5. The retainer as claimed in claim 4, wherein the wedge is configured as a pin.

6. The retainer as claimed in claim 1, wherein the body includes a plurality of adjacent segments.

7. The retainer as claimed in claim 6, wherein the tensioner is receivable between the plurality of adjacent segments to increase a distance between the adjacent segments.

8. The retainer as claimed in claim 1, further including a second anchor feature.

9. The retainer as claimed in claim 8, wherein the tensioner is between the first anchor feature and the second anchor feature.

10. The retainer as claimed in claim 8, wherein the second anchor feature is configured to receive a tensioner.

11. The retainer as claimed in claim 8, wherein the second anchor feature is also the tensioner.

12. An internal permanent magnet rotor, comprising:
a rotor lamination having a magnet opening;
a magnet housed in the magnet opening;
a pole piece; and
a retainer as claimed in claim 1, connecting the lamination and the pole piece.

13. The rotor as claimed in claim 12, wherein the magnet opening is a plurality of magnet openings and the retainer is disposed between adjacent magnet openings.

14. The rotor of claim 13, wherein the retainer is disposed between two adjacent magnets.

15. The rotor of claim 12, wherein the rotor is a double V rotor type.

16. The rotor of claim 12, wherein the rotor is a single V rotor type.

17. The rotor of claim 13 wherein the retainer is comprised of a non magnetically permeable material.

18. A method for assembling an internal permanent magnet (IPM) rotor, comprising:
installing a magnet in a magnet opening of the IPM rotor; and
disposing a retainer as claimed in claim 1 into the IPM rotor.

19. The method as claimed in claim 18, further including tensioning of the retainer.

20. The method as claimed in claim 19, wherein the tensioning includes disposing a tensioner into the retainer.

21. The method as claimed in claim 19, wherein the disposing includes elastically deforming the retainer prior to inserting the retainer in the IPM rotor.
